(19) United States
(12) Patent Application Publication
(10) Pub. No.: US 2020/0338598 A1
(43) Pub. Date: Oct. 29, 2020

(54) SORTING AND SUPPLYING APPARATUS FOR PLURALITY OF PACKAGING PRODUCTS

(71) Applicant: YKMC, Inc., Asan-si (KR)

(72) Inventors: Kwan Seop JANG, Pyeongtaek-si (KR); Gi Bum JANG, Pyeongtaek-si (KR)

(21) Appl. No.: 16/393,020

(22) Filed: Apr. 24, 2019

(51) Int. Cl. B07C 5/20; B07C 5/36; B07C 5/28

(52) U.S. Cl. CPC B07C 5/20; B07C 5/28; B07C 5/362

(57) ABSTRACT

The present invention relates to a sorting and suppling apparatus for a plurality of packaging products, wherein the supply apparatus includes a defect sorting unit which transfers products in a non-defective product transfer direction or a defective product transfer direction and supplies the non-defective products to a shortage supplement unit, and a shortage supplement unit which is formed on a front side of the defect sorting unit and drives a driving motor to move the plurality of packaging products, which are on a supplement conveyor, in a supplement direction so as to supplement products with as many products as the number of sorted and separated defective products.

### BACKGROUND

### 1. Field of the Invention

The present invention relates to a sorting and suppling apparatus, and more specifically, to a sorting and suppling apparatus for a plurality of packaging products which allows a defect sorting unit to detect defects of a plurality of packaging products and supply non-defective products to a shortage supplement unit and which supplements the shortage with as many products as the number of defective products so as to consecutively supply a plurality of non-defective packaging products.

### 2. Discussion of Related Art

Generally, many devices that sort non-defective and defective products by measuring the weight of food, such as fruits or eggs, have been developed, but a defect sorting device suitable for mass-produced industrial products, such as coffee mixes, foodstuffs such as pharmaceutical products, cosmetics, toothpastes, or the like that are filled with a product, has not been developed.

Therefore, since a method of collecting several samples of the mass-produced industrial products filled with the product such as coffee mixes, foodstuffs such as pharmaceutical products, cosmetics, toothpastes, and the like, sorting non-defective and defective products, and measuring the weight of the collected samples using various weight measuring devices, such as scales, is used conventionally, it is inconvenient to sort products, and since all of the mass-produced products are not measured and sorted, the reliability of the product decreases.

The conventional device for solving the problem will be briefly described below. The device used to sort non-defective and defective products by measuring the weight of products includes a frame which forms a shape of device, transfer parts which transfer products one by one, a plurality of impellers in which the products transferred from the transfer part are accommodated, a plurality of rotation motors which are mounted in the frame and to which rotating shafts are connected, an origin sensor which sets origin positions of rotation angles of the plurality of rotation motors, a weight sensor which measures the weight of products that are accommodated in the plurality of impellers, a control unit which receives a signal from the weight sensor and sorts the products, and a supplement conveyor which transfers the products output from the plurality of impellers.

The conventional defect sorting device configured as described above measures the weight of each of the products by operation of the weight sensor and the control unit when the products are input to accommodation spaces of the plurality of impellers by the plurality of transfer parts.

Further, when all measured weight measurement values of the products are within a set error range that is preset in the control unit, the control unit sorts the measured products as non-defective products and simultaneously rotates each of the rotating shafts of the plurality of rotation motors at a predetermined angle.

When the rotating shafts of the plurality of rotation motors are simultaneously rotated, the plurality of impellers are simultaneously rotated at a predetermined angle and the products input to the accommodation spaces of the plurality of impellers simultaneously fall to the supplement conveyor. When any one of weight measurement values of the measured products is out of the preset error range that is input in the control unit in advance, the control unit treats the measured products as defective products and simultaneously rotates the rotating shafts of the plurality of rotation motors at a predetermined angle.

When the rotating shafts of the plurality of rotation motors are simultaneously rotated, the plurality of impellers are simultaneously rotated at a predetermined angle and the products input to the accommodation spaces of the plurality of impellers fall to the supplement conveyor.

However, when the supplement conveyor is disposed vertically under the plurality of impellers into which the products are input and in which the weight of the product are measured, and the products in the impellers fall to the supplement conveyor, the defect sorting device according to the related art allows the supplement conveyor to be selectively driven in a forward or backward direction depending on whether the products are non-defective or defective so as to sort non-defective and defective products. In particular, when any one of the plurality of products is defective, the non-defective products fall to the supplement conveyor while being mixed with the defective products, all of the products are treated as defective products and are output in a defective product processing direction, and the following products are newly sorted. That is, when any one of the plurality of products is defective, non-defective products are also sorted as defective, and all of the products are sorted as defective. Thus, good product sorting slows down so that overall work efficiency decreases, and an additional sorting operation of re-sorting the non-defective products sorted as defective products from a mixture of non-defective and defective products should be performed.

Meanwhile, to solve the above problems, a device for supplying only non-defective products to a packaging process without defective products by sorting non-defective and defective products in advance has been recently disclosed.

Although the defect sorting device according to the related art allows only non-defective products to be transferred to the next process without a mixture of non-defective and defective products sorted as defective, due to the lack of the number of non-defective packaging products due to the omission of the defective products, the product packaging process is not properly performed, or a worker has to manually supplement the shortage in packaging products so that product packaging is properly performed.

### PATENT DOCUMENT

Korean Utility Model Registration No. 20-0464257

### SUMMARY OF THE INVENTION

The present invention is directed to providing a sorting and suppling apparatus for a plurality of packaging products which includes a defect sorting unit and a shortage supplement unit, wherein the defect sorting unit measures the weight of the product and transfers the product in a non-defective product transfer direction or a defective product transfer direction so as to supply non-defective products to a shortage supplement unit, and the shortage supplement unit is formed on a front side of the defect sorting unit and moves the plurality of packaging products that are on a supplement conveyor in a supplement direction by operating a driving motor so as to supplement products with as many products as the number of the sorted and separated defective products. When the non-defective products that are sorted by the defect sorting unit are supplied to the shortage supplement unit, a plurality of non-defective packaging products of the shortage supplement unit are moved in a supplement direction by the supplement conveyor of the shortage supplement unit, and thus the supply apparatus consecutively supplies the non-defective packaging products with as many products as the number of packaging products that are sorted as defective.

According to an aspect of the present invention, there is provided a sorting and suppling apparatus for a plurality of packaging products, the sorting and suppling apparatus for a plurality of packaging products including a plurality of defect sorting units and a shortage supplement unit, wherein the defect sorting units are spaced at predetermined distances in a line and include a sorting conveyor configured to measure a weight of a product that is input from a product input part and transfer the product in a non-defective product transfer direction or a defective product transfer direction, a weight measuring part formed on one side of the sorting conveyor and configured to measure the weight of the input product, a forward-reverse rotation motor configured to rotate the sorting conveyor forward or backward, and a control unit configured to receive a weight measurement value signal of the product from the weight measuring part and determine whether a weight measurement value is within a preset non-defective value range so as to control forward-backward rotation of the forward reverse rotation motor, and the shortage supplement unit includes a supplement conveyor mounted on a front side of the defect sorting unit and configured to transfer the product in a supplement direction so as to supplement products with as many products as the number of sorted and separated defective products of the products transferred from the defect sorting unit, a driving motor configured to drive a conveyor belt of the supplement conveyor in the supplement direction, and a control unit configured to receive a signal of the number of the defective products from the defect sorting unit and control operation of the driving motor to supplement products with as many products as a preset number of non-defective products, wherein the sorting conveyor of each of the defect sorting units includes a driving roller configured to receive power of the forward reverse rotation motor and configured to be axially rotated, a driven roller disposed on a side opposite to the driving roller and spaced by a predetermined distance to be collinear with the driving roller, and a conveyor belt configured to surround the driving roller and the driven roller and slide forward or backward, and the weight measuring part includes a weight detecting part disposed adjacent and parallel to a lower surface of the conveyor belt and configured to detect the weight of the input product, a connection part which has an upper end portion connected with one side of the weight detecting part and a lower end portion extending downward, a cell-upper plate connected with a bottom of the connection part and configured to receive a weight measurement value of the weight detection part through the connection part, a load cell which is connected with the cell-upper plate, measures the weight measurement value of the product transferred to the cell-upper plate, and transfers a weight measurement value signal to the control unit, the weight measuring part further includes a head block provided between a vertically upper surface of the load cell and one lower surface of the cell-upper plate and configured to connect the vertically upper surface of the load cell and the one lower surface of the cell-upper plate to certainly provide the weight measurement value of the product, which is transferred to the cell-upper plate, to the load cell, a plurality of partitions are provided on a surface of the conveyor belt of the shortage supplement unit and are spaced by a predetermined distance in a driving direction to partition the conveyor belt by each product to be supplemented, and the supplement conveyor includes a lifting part configured to be vertically lifted to a predetermined height.

The connection part may further include a roller mounting part which is concave inward so that a roller pulley is disposed therein to be collinear with a motor pulley, wherein the roller pulley is connected with a roller shaft of the driving roller to be axially rotated, and the motor pulley is connected with a motor shaft of the forward-reverse rotation motor to be axially rotated while being mounted in the connection part.

When a product to be supplemented is supplied to an upper surface of the conveyor belt, the supplement conveyor may include an escape preventing wall on a portion thereof, which faces a direction in which the product to be supplemented is supplied, to prevent the supplied product from escaping outward from the upper surface of the conveyor belt.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a sorting and suppling apparatus for a plurality of packaging products according to the present invention;

FIG. 2 is a bottom perspective view illustrating a defect sorting unit of the sorting and suppling apparatus for a plurality of packaging products according to the present invention;

FIG. 3 is a top perspective view illustrating the defect sorting unit of the sorting and suppling apparatus for a plurality of packaging products according to the present invention;

FIG. 4 is a side cross-sectional view schematically illustrating the defect sorting unit of the sorting and suppling apparatus for a plurality of packaging products according to the present invention;

FIG. 5 is a perspective view illustrating a main portion of the shortage supplement unit of the sorting and suppling apparatus for a plurality of packaging products according to the present invention; and

FIG. 6 is a perspective view illustrating an internal main portion of a fixed housing of the shortage supplement unit of the sorting and suppling apparatus for a plurality of packaging products according to the present invention.

### DETAILED DESCRIPTION OF EXEMPLARY EMBODIMENTS

Hereinafter, the present invention will be described below with reference to the accompanying drawings.

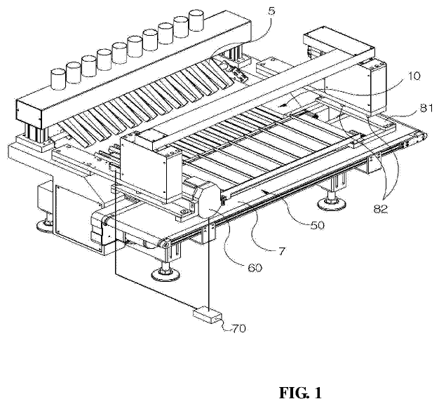

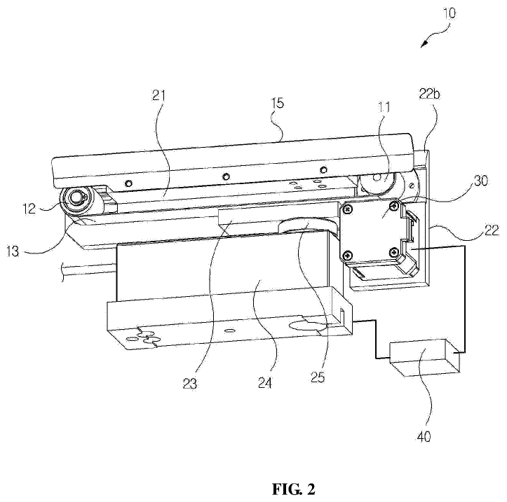

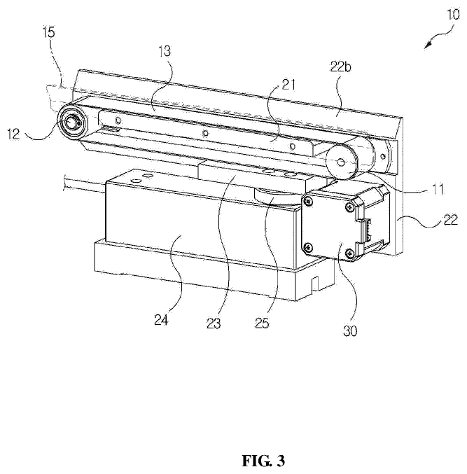

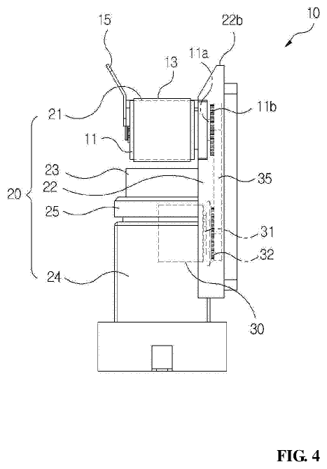

First, as shown in FIGS. 1 to 6, a defect sorting unit according to an embodiment of the present invention includes a sorting conveyor 10, a weight measurement part 20, a forward-reverse rotation motor 30, and a control unit 40.

The sorting conveyor 10 measures the weight of product that is input from a product input part 5 and transfers the product in a non-defective product transfer direction or a defective product transfer direction. The sorting conveyor 10 includes a driving roller 11 which receives power of the forward-reverse rotation motor 30 and is axially rotated, a driven roller 12 disposed on a side opposite to the driving roller 11 to be spaced a predetermined distance from the driving roller 11 collinearly in a horizontal direction, and a conveyor belt 13 which surrounds the driving roller 11 and the driven roller 12 and slides in a forward or backward in a caterpillar manner.

Further, side guards 15 and 22b are provided on both sides of the conveyor belt 13 in a width direction to prevent the falling products from escaping from the sides of the conveyor belt.

The pair of side guards 15 and 22b have upper end portions extending to be inclined upward and laterally outward to have a hopper structure so as to smoothly guide the products falling from above to the conveyor belt 13.

In this case, the one side guard 22b has an inclined surface integrally formed on an upper end portion of a connection part 22.

The weight measurement part 20 is provided on one side of the sorting conveyor 10 to measure the weight of the input product. The weight measurement part 20 includes a weight detecting part 21 disposed adjacent and parallel to a lower surface of the conveyor belt 13 to detect the weight of the input product, a connection part 22 which has a “¬” shape and has an upper end portion connected to one side of the weight detecting part 21 and a lower portion extending downward, a cell-upper plate 23 which is connected with a lower end portion of the connection part 22 and receives a weight detection value of the weight detecting part 21 through the connection part 22, and a control unit 40 which is connected with the cell-upper plate 23, measures the weight detection value of the product transferred to the cell-upper plate 23, and transfers a weight measurement value signal to the control unit 40.

Further, the weight detecting part 21 has a rectangular plate structure that extends to correspond to a full length of the conveyor belt 13 in a longitudinal direction so as to accurately detect a weight value of the product, which falls and is introduced to the conveyor belt 13, throughout the entirety of the upper surface of the conveyor belt 13 in the longitudinal direction.

Due to this structure, when the conveyor belt 13 is pressed downward by the weight of the product falling to the upper surface of the conveyor belt 13, the upper surface of the weight detecting part 21 under a lower surface of the conveyor belt 13 is pressed, and thus the weight detecting part 21 detects a pressure load and the pressure load is transferred to the load cell 24.

Further, a head block 25 for connecting a vertically upper surface of the load cell 24 with one side of a lower surface of the cell-upper plate 23 is provided between the vertically upper surface of the load cell 24 and the one side of the lower surface of the cell-upper plate 23 to certainly provide the weight detection value of the product, which is transferred to the cell-upper plate 23, to the load cell 24.

Further, the connection part 22 includes a roller mounting part 22a which is concave inward so that a roller pulley 11b is disposed therein to be collinear with a motor pulley 32, wherein the roller pulley 11b is connected with a roller shaft 11a of the driving roller 11 to be axially rotated, and the motor pulley 32 is connected with a motor shaft 31 of the forward-reverse rotation motor 30 to be axially rotated while mounted in the connection part 22.

An undescribed symbol 35 refers to a belt that connects the motor pulley 32 with the roller pulley 11b.

The forward-reverse rotation motor 30 performs a function of receiving a signal of the control unit 40 and rotating the sorting conveyor 10 forward or backward.

The control unit 40 receives a weight measurement value signal of the product from the weight measurement part 20, determines whether the weight measurement value is within a preset non-defective value range, and controls forward-reverse rotation of the forward-reverse rotation motor 30.

An operational process of the defect sorting units according to the embodiment of the present invention will be described below.

Hereinafter, the operational process will be described below with reference to a structure in which a plurality of defect sorting units according to the present invention are consecutively disposed in a transverse direction.

First, when the products are input to the plurality of product input parts that have a slide shape, the products fall to an upper surface of the conveyor belt 13 of the defect sorting units corresponding to the product input parts.

In this case, the weight of the falling product is detected by the weight detecting part 21 of the weight measurement part 20, and the weight detection value is transferred to the load cell 24 through the connection part 22, the cell-upper plate 23, and the head block 25.

The control unit 40 receives a signal of the load cell 24 and compares the weight detection value with a preset non-defective value. In this case, when the weight detection value is within a non-defective value range, the control unit 40 drives the forward-reverse rotation motor 30 to allow the products to be transferred in a front direction that is an output direction in which an output conveyor 7 is positioned. On the other hand, when the weight detection value is out of a non-defective value range as compared with the non-defective value, the control unit 40 drives the forward-reverse rotation motor 30 to allow the products to be transferred in a rear direction that is an opposite direction from the output conveyor 7, and thus the defective products are sorted out.

Therefore, when the operation of directly outputting the non-defective products and sorting out the defective products is repeated, only the non-defective products are separately packaged.

As described above, the defect sorting unit according to the embodiment of the present invention includes a sorting conveyor which measures the weight of products input from a product input part and transfers the products in a non-defective product transfer direction or a defective product transfer direction, a weight measuring part which is provided on one side of the sorting conveyor and measures the weight of the input products, a forward-reverse rotation motor for rotating the sorting conveyor forward or backward, and a control unit which receives a weight measurement value signal of the product from the weight measurement part and determines whether the weight measurement value is within a preset non-defective value range and controls forward and backward rotation of the forward-reverse rotation motor. When the weight of the product, which is measured as soon as the product is input from the product input part, corresponds to a preset measurement value, the products are sorted as non-defective and are transferred in the non-defective product transfer direction, and when the weight of the product does not correspond to the preset measurement value, the products are sorted as defective and are transferred in a defective product transfer direction. Thus, only the defective products are sorted out and the non-defective products that are remaining products excluding the defective products are quickly output to a packaging process, and thus working hours can be reduced and working efficiency can be improved.

Further, the weight detecting part of the weight measurement part is disposed adjacent to a lower surface of the conveyor belt, and the connection part, the cell-upper plate, the head block, and the load cell are disposed adjacent to side and rear portions of the sorting conveyor, thereby the device is simplified on the whole, and thus the device can be easily treated and installed, and use of a space around the device can be facilitated.

Meanwhile, after the defective product sorting process of the present invention, a shortage in a line in which a defective product is generated is supplemented by a separate shortage supplement unit to meet the number of non-defective products, and thus the product packaging may be properly performed.

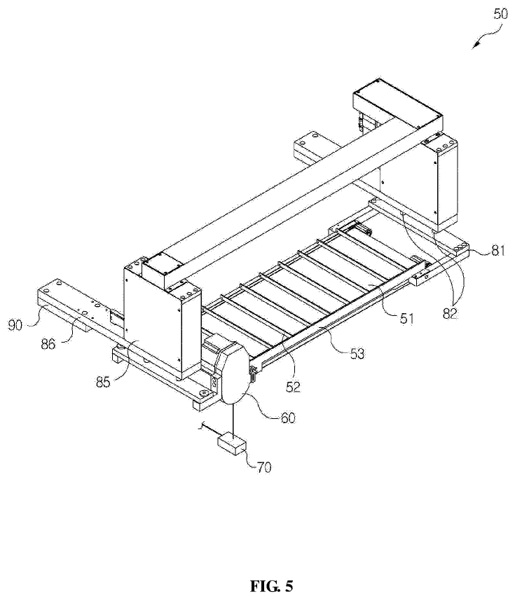

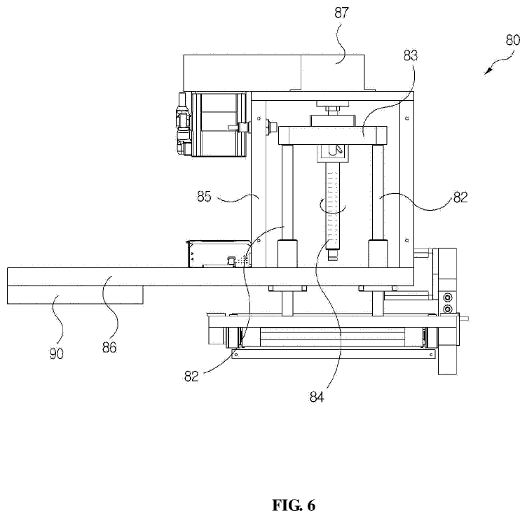

Referring to FIGS. 5 and 6, the shortage supplement unit according to the present invention includes a supplement conveyor 50, a driving motor 60, and a control unit 70.

The supplement conveyor 50 transfers products in a supplement direction to supplement the products with as many products as the number of sorted and separated defective products of the products transferred from the sorting conveyor 10 of the defect sorting unit. The supplement conveyor 50 includes a driving roller (not shown) axially rotated by the driving motor 60, a driven roller (not shown) which is horizontally spaced a predetermined distance from the driving roller and receives rotating force, and a conveyor belt 51 which surrounds the driving roller and the driven roller and slides in a caterpillar manner.

The conveyor belt 51 includes a plurality of partitions 52 which are formed on a surface thereof to be spaced by a predetermine distance in a driving direction and have a long rectangular shape extending in a width direction so as to partition the conveyor belt 51 by each product to be supplemented.

That is, while each supplementing product is disposed between the partitions 52, the required number of products is supplied as a non-defective product by operation of the conveyor belt 51, and thus the product packaging may be performed.

The supplement conveyor 50 includes an escape preventing wall 53, wherein the escape preventing wall 53 is formed on an end portion of the conveyor belt 51 in a width direction that faces a direction in which the supplementing products are supplied and has a long plate shape extending throughout the entirety of the conveyor belt 51 in a longitudinal direction so as to, when products to be supplemented are supplied to an upper surface of the conveyor belt 51, prevent the supplied products from escaping outward from the upper surface of the conveyor belt 51.

The driving motor 60 performs a function of driving the conveyor belt 51 of the supplement conveyor 50 in a supplement direction according to control of the control unit 70.

The control unit 70 performs a function of receiving a signal of the number of defective products from the defect sorting unit and controlling operation of the driving motor 60 to supplement the products with as many products as the number of preset non-defective products.

The supplement conveyor 50 includes a lifting part vertically lifted to a predetermined height.

The lifting part includes a pair of extending frames 81 which extend outward from both ends of the supplement conveyor 50 and have a “C.” shape, a pair of lifting rods 82 which are spaced a predetermined distance from upper surfaces of the extending frames 81 and extending parallel with each other vertically upward from the extending frames 81, a lifting part 83 which connects upper end portions of the pair of lifting rods 82, a lead screw 84 which is screw-coupled with the lifting part 83 while passing through a central portion of the lifting part 83 and vertically lifts the lifting part 83 by axially rotating in place forward or backward, a fixed housing 85 which surrounds the lead screw 84, and a connection part 86 which connects the fixed housing 85 with the fixed main body 90. Thus, when the lead screw 84 axially rotates forward or backward, the extending frames 81 connected with the lifting rods 82 are lifted, and the supplement conveyor 50 is lifted.

An undescribed symbol 87 refers to an axial rotation motor for axially rotating the lead screw 84 forward or backward.

A method of supplementing a shortage using the product shortage supplement apparatus for product packaging according to the embodiment of the present invention will be described below.

First, the control unit 70 detects the number of defective products which are sorted and separated from the products transferred from the defect sorting unit.

The control unit 70 controls operation of the driving motor 60 to supplement the non-defective products with as many products as the number of detected defective products, adds the required number of non-defective products which are in shortage to the non-defective products, the non-defective products sorted by the defect sorting unit to meet the preset number of packaging products, and outputs the non-defective products to a separate packaging process part.

In this case, the defect sorting unit includes a plurality of sorting conveyors 10 which selectively transfer each of the products in a forward or backward direction. The non-defective products, which are sorted as non-defective by the control unit 40, of the products input into the sorting conveyors 10 are transferred to the front side of the sorting conveyor 10 and output to the packaging process part, and the defective products sorted as defective are transferred to the rear side thereof. When the control unit 70 detects the number of products, the control unit 70 drives the supplement conveyor 50 to add as many of the non-defective products as the shortage, and thus the product packaging is properly performed.

That is, the plurality of sorting conveyors 10 are positioned at a predetermined height to make the sorting conveyors 10 slide in a front-rear direction, and an output conveyor 7 is disposed at a predetermined height lower than the sorting conveyors 10 to slide toward any one of left and right directions that are perpendicular to the front-rear direction, and further, the supplement conveyor 50 is disposed at a predetermined height higher than the sorting conveyors 10 to slide in the same direction as that of the output conveyor 7 of the left and right directions that are perpendicular to the front-rear direction. Thus, the non-defective products fall and as many products as the shortage in the non-defective products of the defect sorting unit are supplied from the supplement conveyor 50 to the output conveyor 7, the non-defective products are transferred and fall to the output conveyor 7 so as to meet the preset number of the non-defective products, and the non-defective products are transferred to the packaging process, which is the next process.

Meanwhile, when the non-defective products on the supplement conveyor 50 are completely processed, the supplement conveyor 50 is lowered to the same height as that of the sorting conveyor 10 of the defect sorting unit using a lifting part that vertically lifts the supplement conveyor 50 to receive the non-defective products on the defect sorting unit, and thus a sorting and supplementing operation can be continuously performed without stopping processes.

As described above, in the product shortage supplement apparatus for product packaging according to the embodiment of the present invention and a product shortage supplement method therefor, the product shortage supplement apparatus includes a supplement conveyor for transferring the products in a supplement direction to supplement the products with as many products as the number of defective products, which are sorted and separated from the products transferred from the defect sorting unit, a driving motor for operating the conveyor belt of the supplement conveyor in a supplement direction, and a control unit which receives a signal of the number of defective products from the defect sorting unit and controls operation of the driving motor to supplement the products with as many products as the preset number of non-defective products so as to automatically supplement the shortage with as many products as the number of defective products of the products output through the defect sorting unit, thereby solving an existing problem of delay of non-defective products due to the defective products. Thus, when the non-defective products are consecutively supplied, the accurate amount of shortage is quickly supplemented so that package operation is properly performed, and thus work efficiency can be improved.

Further, the supplement conveyor is provided with the lifting part that is vertically lifted to a predetermined height. When the non-defective products on the supplement conveyor are completely processed, the lifting part lowers the supplement conveyor to the same height as that of the defect sorting unit to receive the non-defective products on the defect sorting unit, and delay of packaging process caused when the non-defective products for the processed products are input to the supplement conveyor is prevented, and thus a packaging process can be smoothly and continuously performed without stopping and work efficiency can be improved.

A sorting and suppling apparatus for a plurality of packaging products according to the present invention allows a product to be sorted as non-defective and to be transferred in a non-defective product transfer direction when the weight of product, which is measured as soon as the products are input from a product input part, corresponds to a preset measurement value and allows the products to be sorted as defective and to be transferred in a defective product transfer direction when the weight of products does not correspond to the preset measurement value, and thus only the defective products are sorted out and the non-defective products that are remaining products excluding the defective products are quickly output to a packaging process, and thus working hours can be saved and working efficiency can be improved.

Further, the supply apparatus automatically supplements the shortage with as many products as the number of defective products of the products output through the defect sorting unit and supplies a plurality of non-defective packaging products so as to solve an existing problem of delay of non-defective products due to the defective products, and when the non-defective products are consecutively supplied, a shortage is quickly and accurately supplemented so that package operation is properly performed, and thus work efficiency can be improved. A supplement conveyor is provided with a lifting part which is vertically lifted a predetermined height, and when all of the non-defective products on the supplement conveyor are completely processed, the lifting part lowers the supplement conveyor to the same height as that of the defect sorting unit to receive the non-defective products on the defect sorting unit, and thus delay of a packaging process caused when the non-defective products for the completely processed products are input to the supplement conveyor is prevented, and thus the packaging process can be smoothly and continuously performed without stopping and work efficiency can be improved.

The above-described sorting and suppling apparatus for a plurality of packaging products according to the present invention is not limited to the above-described embodiments of the present invention, and various modifications made by those skilled in the art to which the present invention pertains is included within the scope of the present invention without departing from the gist of the present invention defined by the following appended claims.

What is claimed is:

1. A sorting and suppling apparatus for a plurality of packaging products, the apparatus comprising:
a plurality of defect sorting units spaced by a predetermined distance in a line and each including a sorting conveyor configured to measure a weight of a product that is input from a product input part and transfer the product in a non-defective product transfer direction or a defective product transfer direction,
a weight measuring part formed on one side of the sorting conveyor and configured to measure the weight of the input product,
a forward-reverse rotation motor configured to rotate the sorting conveyor forward or backward, and
a control unit configured to receive a weight measurement value signal of the product from the weight measuring part and determine whether a weight measurement value is within a preset non-defective value range so as to control forward-backward rotation of the forward reverse rotation motor; and
a shortage supplement unit which includes a supplement conveyor mounted on a front side of the defect sorting unit and configured to transfer the product in a supplement direction so as to supplement products with as many products as the number of sorted and separated defective products of the products transferred from the defect sorting unit,
a driving motor configured to drive a conveyor belt of the supplement conveyor in the supplement direction, and
a control unit configured to receive a signal of the number of the defective products from the defect sorting unit and control operation of the driving motor to supplement products with as many products as a preset number of non-defective products,
wherein each of the sorting conveyors of the defect sorting units includes a driving roller configured to receive power of the forward reverse rotation motor and configured to be axially rotated, a driven roller disposed on a side opposite to the driving roller and spaced by a predetermined distance to be collinear with the driving roller, and a conveyor belt configured to surround the driving roller and the driven roller and slide forward or backward, and
the weight measuring part includes a weight detecting part disposed adjacent and parallel to a lower surface of the conveyor belt and configured to detect the weight of the input product,
a connection part which has an upper end portion connected with one side of the weight detecting part and a lower end portion extending downward,
a cell-upper plate connected with a bottom of the connection part and configured to receive a weight detection value of the weight detection part through the connection part,
a load cell which is connected with the cell-upper plate, measures the weight detection value of the product transferred to the cell-upper plate, and transfers a weight measurement value signal to the control unit,
the weight measuring part further includes a head block provided between a vertically upper surface of the load cell and one lower surface of the cell-upper plate and configured to connect the vertically upper surface of the load cell and the one lower surface of the cell-upper plate to certainly provide the weight detection value of the product, which is transferred to the cell-upper plate, to the load cell,
a plurality of partitions are provided on a surface of the conveyor belt of the shortage supplement unit and are spaced by a predetermined distance in a driving direction to partition the conveyor belt by each product to be supplemented, and
the supplement conveyor includes a lifting part configured to be vertically lifted to a predetermined height.

2. The apparatus of claim 1, wherein the connection part further includes a roller mounting part which is concave inward so that a roller pulley is disposed therein to be collinear with a motor pulley, wherein the roller pulley is connected with a roller shaft of the driving roller to be axially rotated, and the motor pulley is connected with a motor shaft of the forward-reverse rotation motor and axially rotated while being mounted in the connection part.

3. The apparatus of claim 1, wherein, when the product to be supplemented is supplied to an upper surface of the conveyor belt, the supplement conveyor includes an escape preventing wall on a portion thereof, which faces a direction in which the product to be supplemented is supplied, to prevent the supplied product from escaping outward from the upper surface of the conveyor belt.
